(19) United States
(12) Patent Application Publication
(10) Pub. No.: US 2013/0015960 A1
(43) Pub. Date: Jan. 17, 2013

(54) WIRELESS IC TAGS, READER/WRITER FOR WIRELESS IC TAGS, AND WIRELESS IC TAG COMMUNICATION SYSTEM EMPLOYING WIRELESS IC TAG AND READER/WRITER FOR WIRELESS IC TAG

(71) Applicants: Kikuo Kaga, Tokyo (JP); Shigeo Ashizawa, Tokyo (JP)

(72) Inventors: Kikuo Kaga, Tokyo (JP); Shigeo Ashizawa, Tokyo (JP)

(21) Appl. No.: 13/637,714

(22) PCT Filed: Jul. 23, 2010
(86) PCT No.: PCT/JP2010/062861

§ 371 Date: Sep. 27, 2012

(30) Foreign Application Priority Data
Apr. 13, 2010 (JP) 2010-092543

(51) Int. Cl. G06K 7/01

(52) U.S. Cl. 340/10.51

(57) ABSTRACT

An apparatus and a wireless IC tag communication system capable of securely writing and reading data to/from a wireless IC tag through relatively long distance communication are provided.

The wireless IC tag communication system comprises a reader/writer for reading and writing data from/to a wireless IC tag via radio communication and a wireless IC tag constituted by mounting a memory section and an antenna section on a substrate, said reader/writer is adapted to output radio waves at a first frequency for electrically activating the wireless IC tag and radio waves at a second frequency for writing and reading data, said second frequency is different from said first frequency, to thereby electrically activate the wireless IC tag with said radio waves at a first frequency and execute data writing and reading with said radio waves at a second frequency.

### FIELD OF INVENTION

The present invention relates to RFID tags, wireless IC tags so-called as “said RFID tags”, and wireless IC tags to be used in a maintenance system using said IC tags, a reader/writer for a wireless IC tag, and a data communication system employing said wireless IC tag and said reader/writer for a wireless IC tag, and particularly to an apparatus and a system to be used in a product maintenance system, such as large concrete construction maintenance system which requires wide range of communication area.

### PRIOR ART

Concerning constructions, such as buildings, and concrete constructions, such as bridges, tunnels and sewage pipes, it is required to inspect information including the strength of used concrete, the construction history of concrete, etc. before starting a construction work or a repairing work, or after occurrence of disaster such as an earthquake. Such information have been managed by recording them in writing to paper sheets in the past. In the recent time, however, such information have been written to and read from wireless IC tags, which are mixed during preparation of fresh concrete when said fresh concrete is introduced or casted, or after the hardening of said fresh concrete in order to implement the maintenance of constructions (Refer to Patent Document No. 1).

Besides, since the possible communication distance of the wireless IC tags having been used for maintenance of constructions in the past was 3 cm more or less, those wireless IC tags had been attached to the surfaces of concrete constructions, or embedded in the vicinity of the surfaces of concrete construction at the time of casting of fresh concrete, or the like (Refer to Patent Document No. 2).

On the other hand, for said wireless IC tags to be mixed at the time of preparing fresh concrete, non-volatile memory device which uses an FeRAM employing a ferroelectric has been developed as a memory element to be used for an IC tag. This non-volatile memory device comprises an power section for receiving radio waves from the outside and resonating with those radio waves to thereby generate current, an antenna section for accomplishing radio communication and a control section for controlling said power section and said antenna section. The non-volatile memory device has various advantages, in comparison with an EEPROM and the like which have been used for the conventional IC tags, such as more rewriting performance, demand of less voltage, no requirement of a power source, longer life time, and smaller cell size. And presently, single IC tag has been configured such that it has a storage capacity of approximately 8 Kbyte, works as a memory device by own, and works as a CPU being a computing device. The wireless IC tag of the passive type that works in electromagnetic induction system, which is also called as an RFID tag, is configured to use magnetic field generating around the antenna as a transmission medium to carry out communication with the exterior based on the induced electromotive force on the antenna (Refer to Patent Document No. 3).

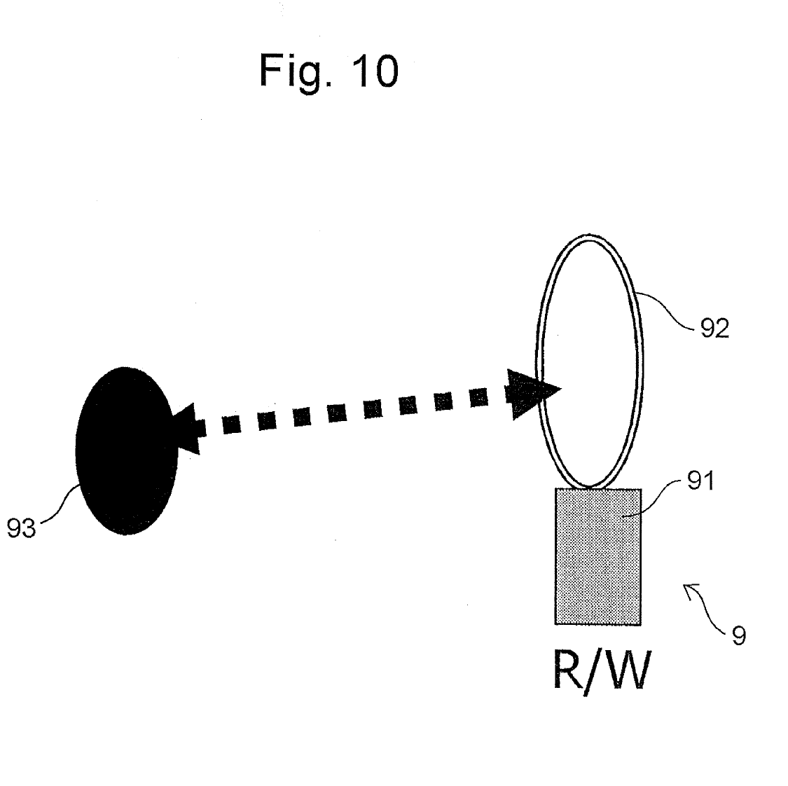

As shown in FIG. 10, however, radio waves that generate current on in a power source and radio waves that perform reading and writing of data belong to radio waves in the same frequency band, because a reader/writer 91 equipped with an antenna 92 and wireless IC tag 93, both being employed in a presently-used communication system 9, perform antenna communication by use of radio waves in one frequency band. Though communication distance may be efficiently extended by increasing the output power of this system, there is a problem that noises are superimposed onto data during the reading and writing of said data, when such output power is increased too much. Besides, in some countries, there is such a regulation that limits the output power of radio waves, for instance, that controls the maximum strength of electric field for a certain distance. On another point of view, said wireless IC tags to be mixed into fresh concrete at the time of preparing said fresh concrete do not always locate at the vicinity of the surface of a concrete construction, and the wireless IC tags do not always locate near the user in the case of a large concrete construction. In case of the concrete construction maintenance system of the aforementioned type, it is required that data transmission/reception between the reader/writer and wireless IC tags locating in places being relatively remote from said apparatus can be carried out, and data transmission/reception to/from wireless IC tags is securely achieved.

[Patent Document 1]: Japanese Unexamined Patent Application Publication No. 2008-063900 [Patent Document 2]: Japanese Unexamined Patent Application Publication No. 2008-138452 [Patent Document 3]: Japanese Unexamined Patent Application Publication No. 2007-241576

### SUMMARY OF INVENTION

The present invention aims at solving the above-described problem, and it is an object of the present invention to provide an apparatus and a communication system which can securely perform data reading and writing from/to a wireless IC tag, which is so-called “RFID tag” to be mainly used for the maintenance system for concrete constructions even though the communication distance between two locations are relatively far.

For solving the above-described problem, the wireless IC tag communication system according to the present invention is characterized in that the system includes a reader/writer for reading and writing data via radio communication to/from a wireless IC tag and a wireless IC tag in which a memory section and an antenna section are mounted on a substrate, and that said reader/writer outputs both radio waves set at a first frequency for electrically activating the wireless IC tag and radio waves set at a second frequency for writing and reading data, said second frequency is different from the first frequency, and current is generated in the wireless IC tag by means of said radio waves at a first frequency and writing and reading data is executed by means of said radio waves at a second frequency.

The wireless IC tag communication system according to the other embodiment of the present invention is characterized in that the reader/writer alternately outputs radio waves set at a first frequency for electrically activating a wireless IC tag and radio waves set at a second frequency for writing and reading data to thereby activate the wireless IC tag so that data can be read and written from/to the wireless IC tag.

Besides, the reader/writer is characterized to simultaneously output radio waves set at a first frequency for electrically activating a wireless IC tag and radio waves set at a second frequency for writing and reading data to thereby activate the wireless IC tag so that data can be read and written from/to the wireless IC tag.

Further, the wireless IC tag communication system according to any of claims 1 to 3 of the present invention is characterized in that the reader/writer and the wireless IC tag carry out communication by means of the electromagnetic induction system.

Further, the wireless IC tag communication system according to any of claims 1 to 4 of the present invention is characterized in that the reader/writer and the wireless IC tag carry out communication by means of the radio wave system.

Further, the wireless IC tag communication system according to the other embodiment of the present invention is characterized in that the reader/writer writes and reads data to/from the wireless IC tag via radio communication and outputs radio waves set at a first frequency for electrically activating the wireless IC tag and radio waves set at a second frequency for writing and reading data.

Further, the wireless IC tag communication system according to still other embodiment of the present invention is characterized in that the reader/writer alternately outputs radio waves set at a first frequency for electrically activating the wireless IC tag and radio waves set at a second frequency for writing and reading data.

Further, the wireless IC tag communication system according to still other embodiment of the present invention is characterized in that the reader/writer simultaneously outputs radio waves set at a first frequency for electrically activating the wireless IC tag and radio waves set at a second frequency for writing and reading data.

Further, the wireless IC tag communication system according to still other embodiment of the present invention is characterized in that the reader/writer includes an electromagnetic induction circuit and outputs radio waves by means of electromagnetic induction which applies alternating current to a coil antenna to thereby generate alternating current magnetic field.

Further, the wireless IC tag communication system according to still other embodiment of the present invention is characterized in that the reader/writer includes a reflection circuit and outputs radio waves by means of the radio wave system which carried out communication between a wireless IC tag and a communication tag by means of radio waves being reflected to a plate-formed antenna.

The wireless IC tag is configured to receive radio waves set at a first frequency for electrically activating the wireless IC tag, said radio waves are output from the reader/writer, and radio waves set at a second frequency for writing and reading data, said second frequency is different from the first frequency, and to include either of an electromagnetic induction circuit for receiving radio waves by means of the coil antenna or a reflection circuit for receiving radio waves by means of a plate-formed antenna, or both of an electromagnetic induction circuit for receiving radio waves by means of the coil antenna and a reflection circuit for receiving radio waves by means of the plate-formed antenna.

The memory section constituting a wireless IC tag is characterized in that it is a non-volatile memory employing a ferroelectric, which comprises a power section for receiving radio waves from the reader/writer to resonate with said radio waves, thereby generating current.

### ADVANTAGEOUS EFFECT OF THE INVENTION

The wireless IC tag communication system according to the present invention includes a reader/writer for reading and writing data from/to a wireless IC tag by means of radio communication and a wireless IC tag, in which a memory section and an antenna section are mounted on a substrate, said reader/writer is adapted to output radio waves set at a first frequency for electrically activating the wireless IC tags and radio waves set at a second frequency for writing and reading data, said second frequency is different from the first frequency, to thereby operate the power section of the wireless IC tags by means of the radio waves set at a first frequency and execute data writing and reading by means of the radio waves set at a second frequency. For example, the wireless IC tag communication system according to the present invention may activate the power source of a wireless IC tag by means of the radio waves set at a first frequency capable of achieving relatively long distance communication and cause the activated wireless IC tag to read and write data by means of the radio waves set at a second frequency to thereby securely execute data reading and writing from/to the wireless IC tag so-called RFID tag via long distance communication. Furthermore, with this wireless IC tag communication system, the read and written data may be affected with less noise. In particular, said data reading and writing from/to the wireless IC tag can be achieved securely even though the wireless IC tag is mixed or embedded inside a concrete construction and it cannot be seen from the outside.

Further, in the wireless IC tag communication system according to the present invention, said reader/writer alternately outputs radio waves set at a first frequency for electrically activating the wireless IC tag and radio waves set at a second frequency for writing and reading data to actuate the wireless IC tag and to read and write data so that the wireless IC tags can be surely operated and data reading and writing can be done securely, even though the radio waves at both first and second frequencies are output from the same antenna section.

Still further, said reader/writer may simultaneously output radio waves set at a first frequency for electrically activating the wireless IC tag and radio waves set at a second frequency for writing and reading data to cause the wireless IC tags to operate and to execute reading and writing of data so that the wireless IC tag can be securely operated and data reading and writing is securely executed, even though the radio waves respectively set at said first and second frequencies are output separately through circuits of the different systems.

Further, according to the present invention, said reader/writer may generate alternating magnetic field by virtue of alternating current to be applied to a coil to communicate with the wireless IC tag by means of electric induction, thereby securely implementing data communication from vicinity to neighborhood.

Still further, according to the present invention, said reader/writer includes a reflection circuit so that the reader/writer can perform communication between a wireless IC tag and a communication tag via radio waves to securely execute long distance data communication.

Besides, the reader/writer used in the communication system according to the present invention, which is adapted to execute data writing and reading to/from a wireless IC tag, outputs radio waves set at a first frequency for electrically activating the wireless IC tag and radio waves set at a second frequency for writing and reading data to thereby actuate the power source of the wireless IC tag by means of the radio waves set at a first frequency capable of executing relatively long distance communication and to perform reading and writing of data from/to the activated wireless IC tag by means of the radio waves set at a second frequency so that data reading and writing from/to wireless IC tags so-called RFID tags via long distance communication can be securely achieved. In particular, said data reading and writing from/to the wireless IC tags can be achieved securely even though the wireless IC tag is mixed or embedded inside a concrete construction and it cannot be seen from the outside.

Besides, according to the present invention, said reader/writer may alternately output radio waves set at a first frequency for electrically activating the wireless IC tags and radio waves set at a second frequency to securely actuate the power source of the wireless IC tag and to surely read and write data even though the radio waves set at a first frequency and the radio waves set at a second frequency are output via the same antenna section.

Further, according to the present invention, said reader/writer may simultaneously output the radio waves set at a first frequency for electrically activating the wireless IC tag and the radio waves set at a second frequency for writing and reading data to securely actuate the power source of a wireless IC tag and to surely read and write data, even though the radio waves respectively set at first and second frequencies are output separately from circuits of the different systems.

Still further, according to the present invention, the reader/writer includes an electromagnetic induction circuit and may apply alternating current to the coil antenna to thereby output radio waves for generating alternating electric field by virtue of electromagnetic induction so that data communication with the vicinity to the neighborhood can be accomplished securely.

Still further, according to the present invention, the reader/writer includes a reflection circuit and may output radio waves in such a manner that communication between a wireless IC tag and a communication tag is achieved by means of radio waves reflected to a plate-formed antenna to thereby securely execute long distance data communication.

The wireless IC tag used in the communication system according to the present invention is a wireless IC tag which receives radio waves set at a first frequency for electrically activating the wireless IC tag, said radio waves are output from the reader/writer, and radio waves set at a second frequency for writing and reading data, said second frequency is different from said first frequency, and includes either an electromagnetic induction circuit adapted to receive radio waves by means of a coil antenna or a reflection circuit adapted to receive radio waves by means of a plate-formed antenna, or both of an electromagnetic induction circuit adapted to receive radio waves by means of a coil antenna and a reflection circuit adapted to receive radio waves by means of a plate-formed antenna so that secure data communication can be achieved by using a circuit and an antenna complying with the frequency band to be output.

Besides, the memory section constituting a wireless IC tag is a non-volatile memory employing a ferroelectric including a power source which receives radio waves from the reader/writer and resonates with said radio waves to thereby generate current. Therefore, a wireless IC tag capable of operating without loading a power source such as a battery therein and of the passive type being operable by virtue of power supply from the reader/writer can be provided.

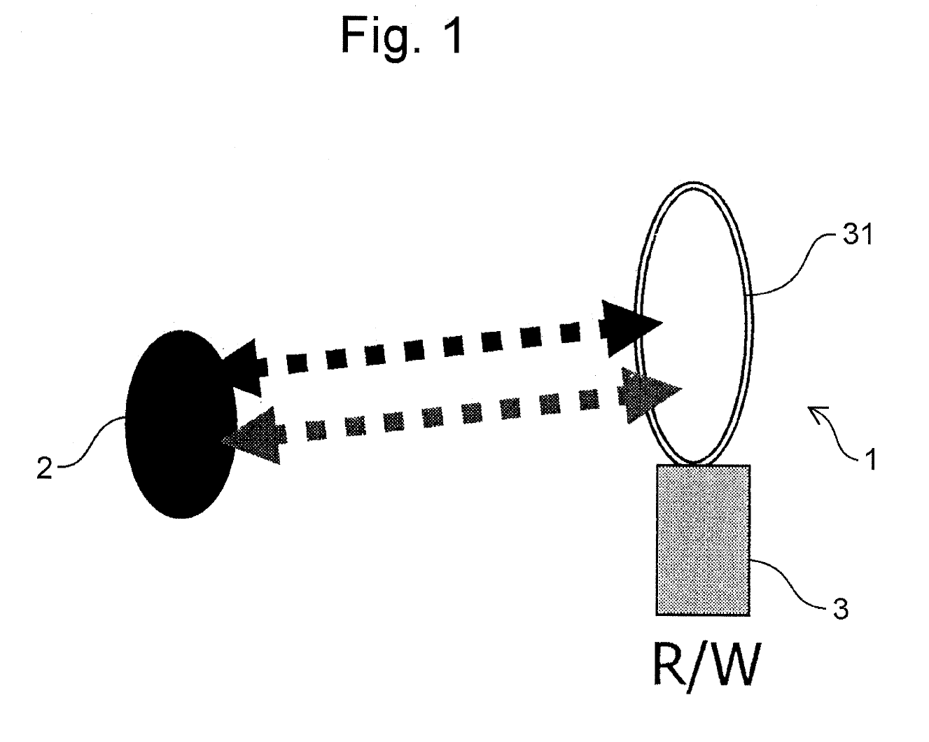

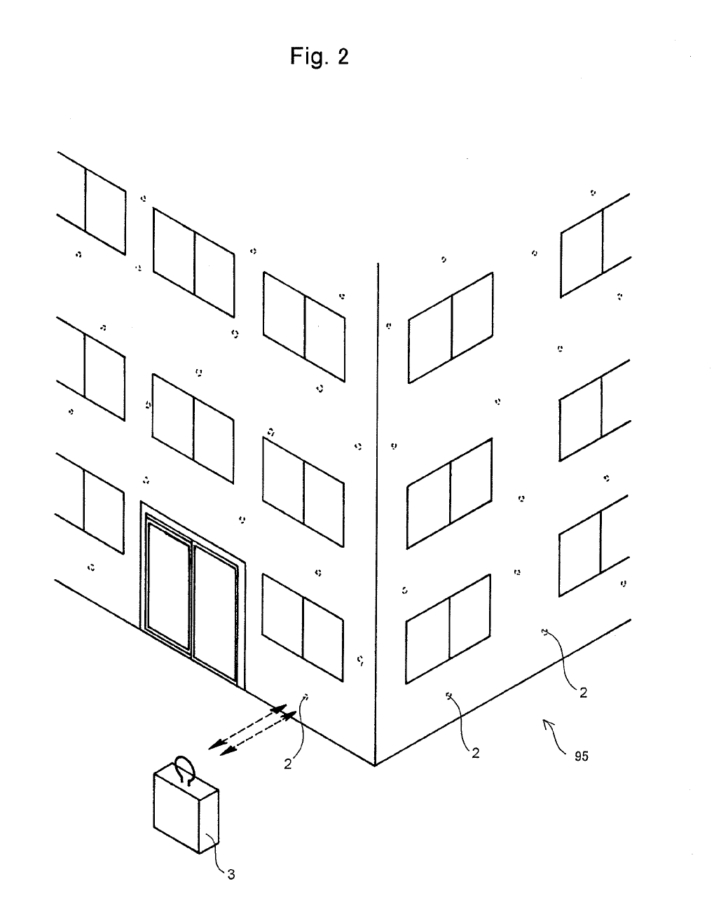

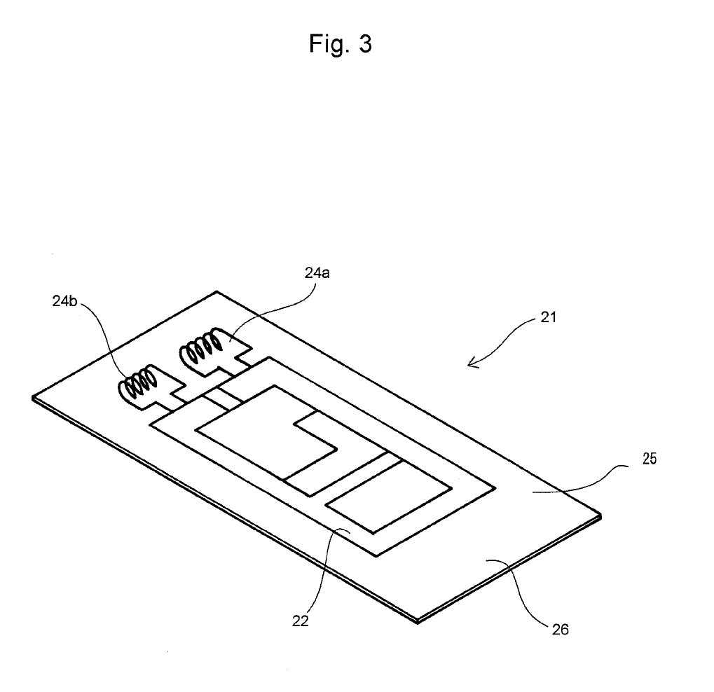

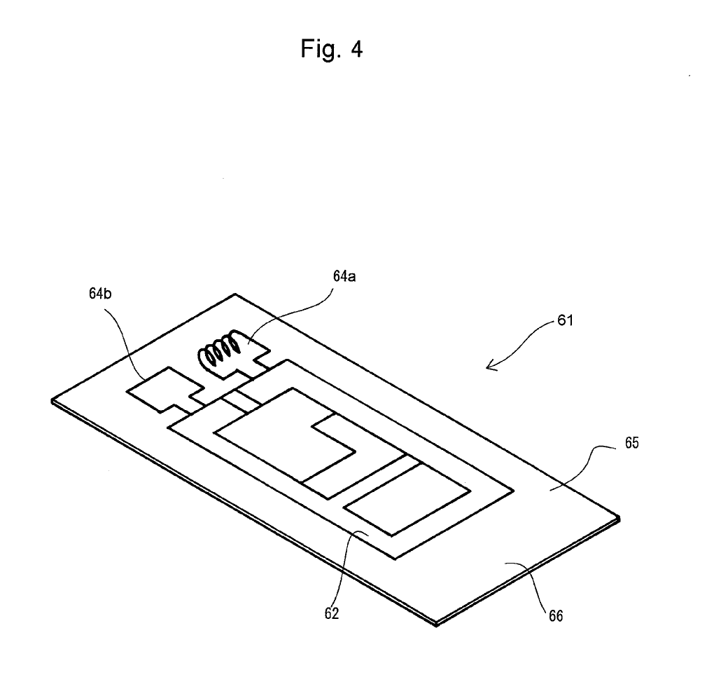

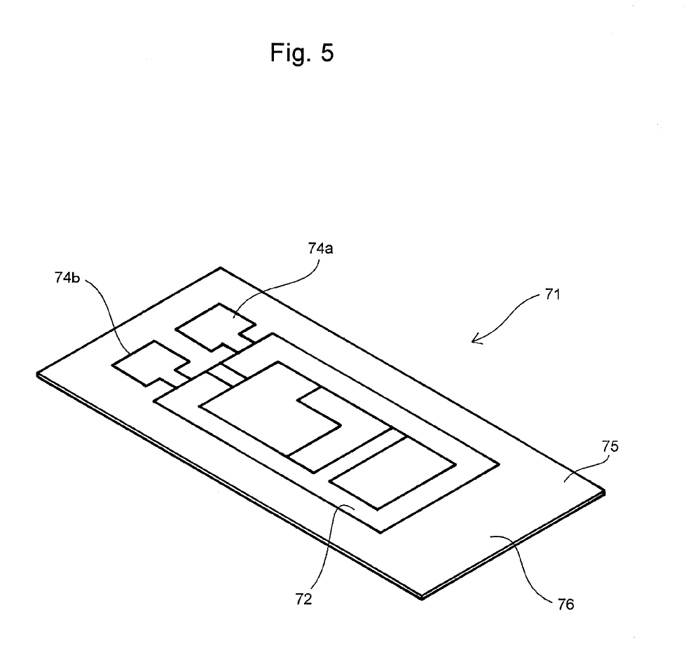

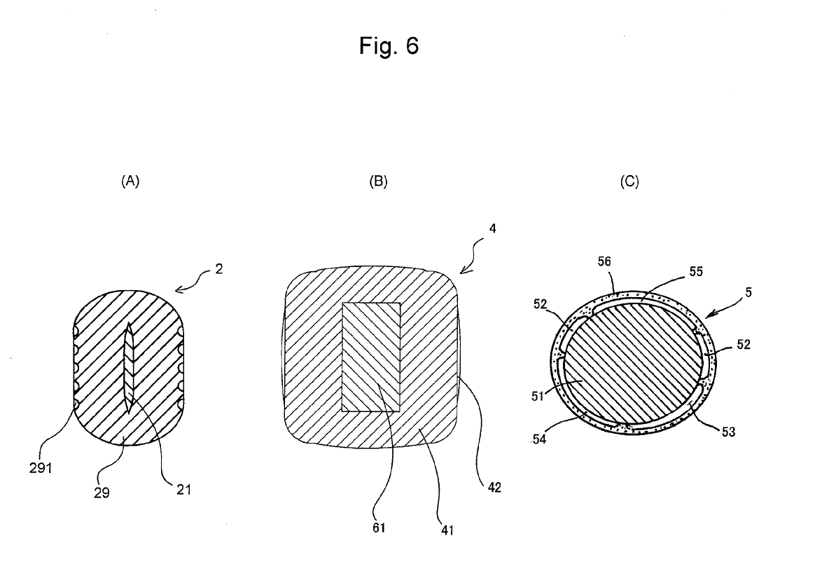

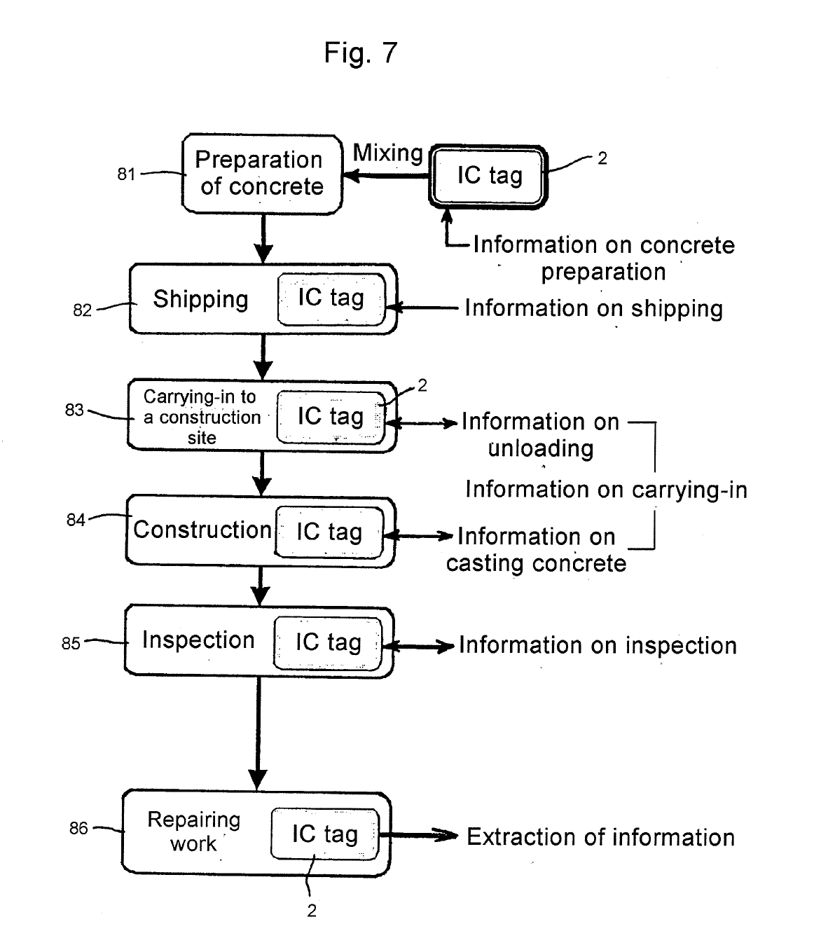

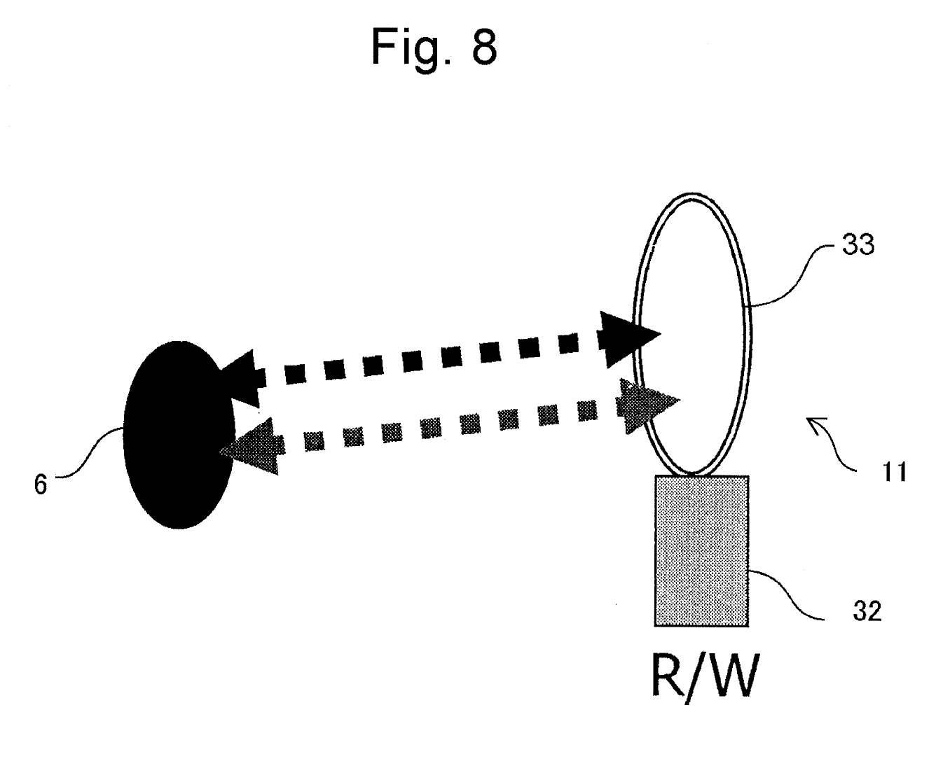

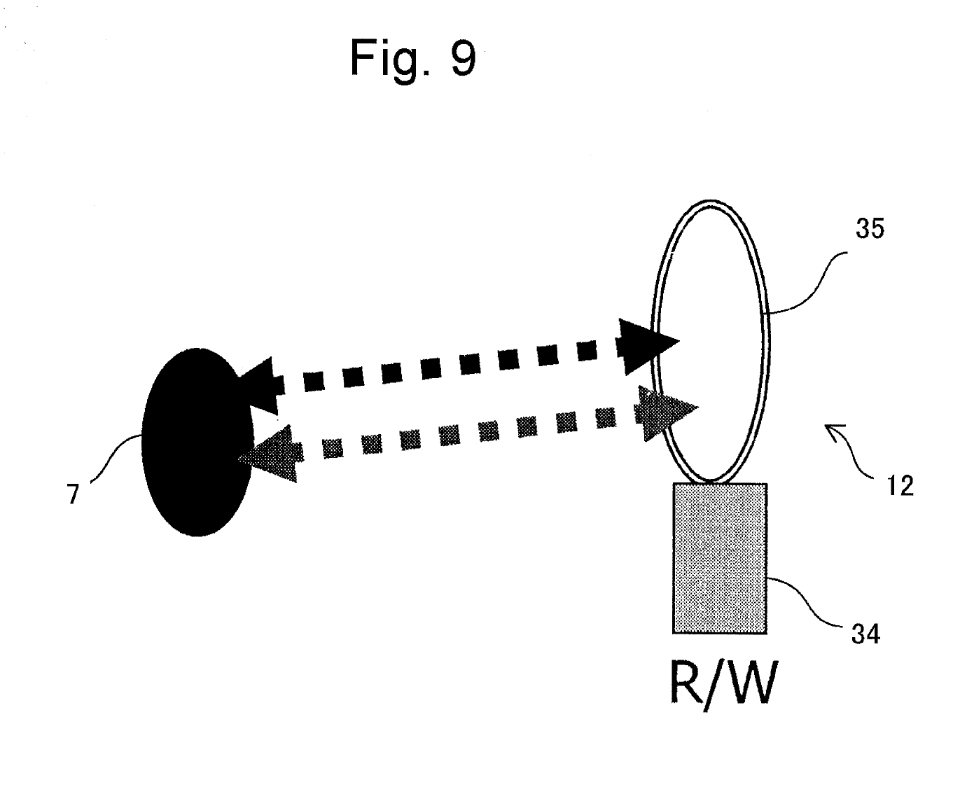

### BRIEF DESCRIPTION OF THE DRAWINGS

[FIG. 1] A schematic showing the system according to the present invention, and a wireless IC tag and a reader/writer adapted to be used for the system.

[FIG. 2] A schematic showing a condition when the system according to the present invention is used.

[FIG. 3] A schematic perspective view of the wireless IC tag main body according to the present invention.

[FIG. 4] A schematic perspective view of the wireless IC tag main body according to the present invention.

[FIG. 5] A schematic perspective view of the wireless IC tag main body according to the present invention.

[FIG. 6] A view showing the cross sections of different types of wireless IC tags according to the present invention.

[FIG. 7] A flow chart of the concrete construction maintenance system according to the present invention.

[FIG. 8] A schematic showing the system according to the present invention, and a wireless IC tag and a reader/writer adapted to be used for the system.

[FIG. 9] A schematic showing the system according to the present invention, and a wireless IC tag and a reader/writer adapted to be used for the system.

[FIG. 10] A schematic showing the system according to the present invention, and a wireless IC tag and a reader/writer adapted to be used for the system.

### DESCRIPTION OF REFERENCE NUMERALS

1: Wireless IC tag communication system
11: Wireless IC tag communication system
12: Wireless IC tag communication system
2: Wireless IC tag
21: Wireless IC tag main body
22: Memory section
23: Circuit
24a, b: Coil antenna
25: Substrate
26: IC chip
29: Cladding body
291: Dimple
3: Reader/writer
31: Antenna
32: Reader/writer
33: Antenna
34: Reader/writer
35: Antenna
4: Wireless IC tag
41: Cladding body
42: Convex section
5: Wireless IC tag
51: Base material
52: Antenna section
53, 54: Circuit
6: Wireless IC tag
61: Wireless IC tag main body
62: Memory section
64a: Coil antenna
64b: Plate-shaped antenna
65: Substrate
66: IC chip
7: Wireless IC tag
71: Wireless IC tag main body
72: Memory section
74a: Plate-shaped antenna
74b: Plate-shaped antenna
75: Substrate
76: IC chip
81: Preparation stage
82: Shipping stage
83: Carrying-in stage
84: Construction stage
85: Inspection stage
86: Repairing work
9: Wireless IC tag communication system
91: Reader/writer
92: Antenna
93: Wireless IC tag
95: Concrete construction

### BEST MODE FOR CARRYING OUT THE INVENTION

Now, the wireless IC tag communication system according to the present invention, the wireless IC tag and the reader/writer adapted to be used for said communication system will be described in the following with reference to the appended drawings.

As shown in FIG. 1, the wireless IC tag communication system according to the present invention is constituted in such a system that radio waves set at a first frequency for causing the memory section to operate and radio waves set at a second frequency for reading and writing data are output from the reader/writer 3, the wireless IC tag 2 receives said radio waves set at a first frequency to cause the memory section to operate so that the memory section comes to the stand-by state, and the wireless IC tag 2 having had received said radio waves set at a second frequency is caused to read and write data. For example, even when long distance data communication is required between the reader/writer and a wireless IC tag 2 which is mixed in a concrete construction 95 as shown in FIG. 2 and its embedded positions is unknown, reading and writing of data from/to the wireless IC tags is securely achieved with this system. In the following, the apparatuses used in this system and the system itself will be explained in detail.

In the first place, the wireless IC tag 2 will be explained. As shown in FIG. 3, the wireless IC tag main body 21 constituting a wireless IC tag 2 used in the wireless IC tag communication system 1 according to the present invention is a non-contact type memory device so-called RFID tag capable of writing and reading data and is constituted of a memory section 22 provided with a control section comprising a non-volatile memory employing a ferroelectric as a memory element for an IC tag and IC chip 26 in which coil antennas 24a, 24b are electrically connected and mounted on a substrate 25. As described later, the wireless IC tag main body 21 shall be coated with a cladding body made of a synthetic resin or the like when it is required.

The memory section 22 constituting an IC chip 26 may be either the active-type or the passive-type. However, such a type that suits to the maintenance system where the replacement of the wireless IC tags is difficult, for example, where the wireless IC tag is used in the state that it has been mixed in a concrete construction, is the passive-type wireless IC tag employing a non-volatile memory including the power section which receives radio waves from the reader/writer 3 and resonates with said radio waves to generate current. As an example of the non-volatile memory, a non-volatile ferroelectric memory device so-called FeRAM, which does not load a power source but rectifies radio waves for data access from the outside to use said rectified radio waves as the power source, can be used. FeRAM has excellent performance, for example, the possible rewriting times thereof will be more than 10 to the thirteenth, which is superior than 10 to the fifth more or less of EEPROM, the later is a non-volatile memory device for the conventional wireless IC tags. Besides, with regard to the voltage required for writing data, EEPROM requires 12 V. In comparison thereto, FeRAM requires far lower voltage in such a range of from DC 1.1 V to 3 V in order to execute writing data. Since the wireless IC tag used in this invention includes a power source which resonates with radio waves from the outside to generate current and does not load a battery therein, FeRAM can achieve data writing at a speed 5,000 times faster than the speed of EEPROM having been used for the conventional IC tags. In addition, the possible data storage period of FeRAM will be more than 10 years.

Further, contrary to that data writing to the conventional EEPROM and flush memory is executed by a block unit, FeRAM has an advantageous characterized in that it can carry out data writing at random by a word unit. It is further possible to set up the control unit of FeRAM such that a postscript can be added to FeRAM but overwriting to FeRAM cannot be done, and it is recommendable to execute data writing and reading according to an encoded protocol. Therefore, various data can be written and read to/from a memory provided with a capacity of approximately 8 KB at every occasion via radio communication with the reader/writer 3 as a reading/writing apparatus. The band of radio waves at which an IC chip 26 can perform radio communication may be fixed freely, and therefore, communication may be executed with not only bands ranging from LF band to UHF band, which are suitable for small-scale radio communication, but also microwave bands.

Further, an administrative flag which can be read by the reader/writer 3 is stored in the memory section 22 either beforehand or at time of writing, and the administrative flag is read when the reader/writer 3 executes writing and reading of information so that it may be distinguishable that a wireless IC tag 2 is a constituent of a definite maintenance system. Note that an anti-collision function, such as space sharing system to share the space for communication to a wireless IC tag 2, frequency sharing multiplex system to share frequencies for communication, and time sharing system to alter the timing of a reply from the wireless IC tag, can be loaded to a wireless IC tag 2 to thereby avoid from such a situation that no communication is available due to a fact that a plurality of wireless IC tags are positioned in the communication range for the reader/writer 3.

Specifically, the IC chip 26 in the wireless IC tag main body 21 comprises a logic memory section (equivalent circuit) including a load resistance, an analog section including a rectification circuit and an input control resistance, a transmission/reception circuit and antenna sections 24a, 24b, those which are electrically connected to one another and mounted on a substrate 25. Besides, in this embodiment, the communication distance may be adjusted either by appropriately setting the value of a load resistance and an input control resistance or by matching the antenna section 24a, 24b, such as adjustment of the winding number of a coil of a coil antenna in an IC chip 26.

The wireless IC tag main body 21 of the wireless IC tag 2 receives radio waves respectively set at two different frequencies from the reader/writer 3 by means of two-frequency communication system. For example, the wireless IC tag main body 21 is constituted such that it receives from the reader/writer 3 radio waves set at 125 KHz for actuating the memory section of the wireless IC tag 2 and radio waves set at 13.56 KHz for reading and writing data, then electrically activate the power section of the wireless IC tag by means of radio waves at 125 KHz for actuating the wireless IC tag 2 following to activating the memory section 22 and various loaded driving circuits, and receives data to be sent by means of radio waves at 13.56 KHz to store them in the memory section 22.

The wireless IC tag main body 21 employs the electromagnetic induction system to carry out communication while using two coil antennas and utilizes magnetic field generated between the reader/writer 3 and a wireless IC tag to execute power supply and data transmission from the reader/writer 3 to the wireless IC tag 2 via communication based on electromagnetic induction system. The wireless IC tag main body 21 provided with coil antennas of the electromagnetic induction system is adapted to receive radio waves at 125 KHz capable of achieving long distance communication to operate the memory section 22 and the other driving circuits by means of the antenna 24b, and then receives radio waves at 13.56 KHz to securely carry out data communication by means of the antenna 24a. Since magnetic strength in the electromagnetic induction system deteriorates in proportion to an inverse number of the square of a distance, this system suits to communication with the vicinity or the neighborhood, and secure data writing can be accomplished with this system. Note that it is also possible to load just one coil antenna to the wireless IC tag main body 21 in order to receive both radio waves at two different frequencies.

FIG. 4 shows a wireless IC tag main body 61 as a variation of the wireless IC tag main body 21 of FIG. 3. This wireless IC tag main body 62 is a non-contact type memory device so-called RFID tag capable of writing and reading data and consists of a memory section 62 comprising a control section so-called a non-volatile memory which employs a ferroelectric as a memory element for an IC tag and an IC chip 66 in which a coil antenna 64a and a plate-shaped antenna (a substrate antenna) 64b are electrically connected and mounted on a substrate 65. As described later, the wireless IC tag main body 61 shall be coated with a cladding body made of a synthetic resin material or the like when it is required.

Specifically, the IC chip 66 of the wireless IC tag main body 61 consists of a logic memory section (equivalent circuit) including a load resistance, an analog section including a rectification circuit and an input control resistance, a transmission/reception circuit, and a substrate 65 on which a coil antenna section 64a and a plate-shaped antenna section 64b are electrically connected and mounted. In this embodiment, the communication distance is regulated by appropriately setting a load resistance and an input control resistance to the IC chip 26, or by adjusting an antenna, such as adjustment of the winding times of a coil of the coil antenna and selection of a plate-shaped antenna.

The wireless IC tag main body 61 employs a hybrid system of loading both of a coil antenna 64a and a plate-shaped antenna 64b and executes communication by means of electromagnetic induction system wherein magnetic field generated between the reader/writer 3 and a wireless IC tag is utilized to carry out power supply and data transmission from the reader/writer 3 to the wireless IC tag 2. At the same time, the plate-shaped antenna utilizes radial electromagnetic waves (radio waves) to supply power from the reader/writer 3 to a wireless IC tag and to transmit data by means of the reflected waves (radio waves). For example, the wireless IC tag 2 is adapted to be operated by electrically activating the power section, and then the memory section and the other driving circuits by means of radio waves set at 125 KHz having been received via the coil antenna 64a and to receive the transmitted data and store them in the logic memory section by means of radio waves set at 860 MHz having been received via the plate-shaped antenna 64b. Note that the combination of the antennas and the combination of the first frequency and the second frequency are not limited to the examples described above. Such combinations may be appropriately selected depending on the communication distance, required degree of accuracy in data writing and so on.

FIG. 5 shows a wireless IC tag main body 71 to be used for the wireless IC tag, which is a variation of the wireless IC tag main body 21 shown in FIG. 3. This wireless IC tag main body 71 is a non-contact type memory device so-called RFID tag capable of writing and reading data and consists of an FeRAM 72 comprising a control section so-called a non-volatile memory which employs a ferroelectric as a memory element for an IC tag and an IC chip 76 in which a plate-shaped antenna (a substrate antenna) 74a and another plate-shaped antenna (a substrate antenna) 74b are electrically connected and mounted on a substrate 75. As described later, the wireless IC tag main body 71 shall be coated with a cladding body made of a synthetic resin material or the like when it is required.

The IC chip 76 of the wireless IC tag main body 71 consists of a logic memory section (equivalent circuit) including a load resistance, an analog section including a rectification circuit and an input control resistance, a transmission/reception circuit, and a substrate 75 on which a plate-shaped antenna section 74a and a plate-shaped antenna section 74b are electrically connected and mounted. In this embodiment, the communication distance is regulated by appropriately setting a load resistance and an input control resistance to an IC chip 76.

The wireless IC tag main body 71 carries out communication by employing the radio wave system provided with plate-shaped antennas 74a, 74b, where it utilizes radial electromagnetic waves (radio waves) by means of the plate-shaped antenna to supply power from the reader/writer 3 to the wireless IC tag so that data transmission is achieved by means of the reflected waves (radio waves). For example, the power section is electrically activated with radio waves at 860 MHz to be received via the plate-shaped antenna 74a to thereby actuate the memory section 72 and the other loaded driving circuits so that the wireless IC tag 2 is started to operate, said wireless IC tag is adapted to receive data sent by means of radio waves at 2.45 GHz received via the plate-shaped antenna 74b and store the data in the logic memory section. Note that the combination of the antennas and the combination of the first frequency and the second frequency are not limited to the examples described above. Such combinations may be appropriately selected depending on the communication distance, required degree of accuracy in data writing and so on.

Note that the wireless IC tag may be an active-type wireless IC tag which loads a power source, such as batteries, on the wireless IC tag and employs a volatile memory as its memory section. In this case, the wireless IC tag is adapted to load batteries as the power source and to operate the volatile memory with the loaded batteries. However, it may be configured such that the operation with batteries is limited to the minimum range for maintaining data stored in the volatile memory and the radio waves set at a first frequency from the reader/writer 3 may be used to operate the other circuits, while the radio waves set at a second frequency may be used to read and write data.

The wireless IC tag 2 as shown in FIG. 6(A), which is mixed with fresh concrete and is used for the maintenance of a concrete construction 95, is formed by coating the wireless IC tag main body 21, which consists of an IC chip 26 comprising a substrate 25 in which antennas 24a, 24b are mounted to a circuit 23 including a memory section 22, with a cladding body 29 being consisted of a RENY material (manufactured by Mitsubishi Engineering Plastics Co., Ltd.), which is obtained by reinforcing an alkaline-resistant resin material, for example polyamide MXD6, with non-magnetically-permeable glass fibers, an inorganic filler or the like, and the wireless IC tag 2 has an elliptic shape nor a bale shape, on the circumference of which dimples are formed in order to increase the affinity with fresh concrete and has a size and a specific gravity, which is substantially equivalent to those of an aggregate to be mixed to fresh concrete so that the wireless IC tags can be distributed homogeneously in the fresh concrete when they are mixed with the fresh concrete.

Besides, the wireless IC tag 4 as an example of the other type of the cladding body as shown in FIG. 6(B) is an IC tag obtained by coating a wireless IC tag main body 61 comprising an IC chip with a cladding body 41 being consisted of RENY material (manufactured by Mitsubishi Engineering Plastics Co., Ltd.), which is prepared by strengthening an alkaline-resistant resin material, e.g. polyamide MXD6, with a non-magnetically-permeable glass fibers, an inorganic filler or the like, and the wireless IC tag 4 has a barrel shape, on the circumference of which convex portions 42 are formed so that the wireless IC tag may acquire sufficient affinity with fresh concrete and has a size and a specific gravity, which is substantially equivalent to those of an aggregate to be mixed to fresh concrete, so that the wireless IC tags can be distributed homogeneously in the fresh concrete when they are mixed with the fresh concrete.

Further, in the wireless IC tag 5 as another example of the other type of the cladding body as shown in FIG. 6(C), antenna sections 52, memory section 53 and circuits 54, 55, those which constitute the wireless IC tag main body, are mounted on the surface of a base material 51. The circumference of the wireless IC tag main body is coated with a cladding body 56 to be formed into a three dimensional structure, such as a spherical body, an elliptic body and a polygonal body, said structure has a size and a specific gravity, which is substantially equivalent to those of an aggregate to be mixed to fresh concrete, so that the wireless IC tags can be distributed homogeneously in the fresh concrete when they are mixed with the fresh concrete. Note that the combination of the wireless IC tag main body and the enclosure is not limited to the examples described above and any desired combinations may be selected.

Now, the reader/writer 3 will be explained. The reader/writer shown in FIG. 1 is a reading/writing 3 apparatus for carrying out data communication with a wireless IC tag and is adapted to output radio waves set at two or more different frequencies. For example, radio waves set at 125 KHz for actuating the memory section of the wireless IC tag 2 and radio waves set at 13.56 MHz for reading and writing data are alternately or simultaneously output from different circuits by switching the switches provided for those circuits. Note that the interval between said alternate output of two different radio waves is a short period of one second or less.

The reader/writer 3 loads a circuit of the electromagnetic induction system which outputs radio waves set at a first frequency via a coil antenna of the electromagnetic induction circuit. The reader/writer 3 outputs radio waves set at 125 KHz from the first circuit via an antenna to thereby actuate the power section of the wireless IC tag 2 and outputs radio waves set at 13.56 MHz from the second circuit via a coil antenna 32 to read and write data. The wireless IC tag 2 is operated with inductive coupling generated by alternating magnetic field energy at the antennas of the reader/writer 3 to execute data reading and writing. The two different frequency radio waves from the antennas may be output either alternately or simultaneously.

Beside, the reader/writer 32 provided with an antenna 33 according to a different embodiment shown in FIG. 8 includes a hybrid-type circuit consisting of an electromagnetic induction circuit and a radio wave system circuit and outputs radio waves set at two different frequencies via a coil antenna and a plate-shaped antenna. For example, the reader/writer 32 outputs radio waves at 13.56 MHz via the coil antenna of the electromagnetic induction system to electrically activate the power section of the wireless IC tag 6 to which the wireless IC tag main body 61 is loaded and then to output radio waves at 860 MHz via the palate-shaped antenna of the radio wave system circuit to read and write data. The wireless IC tag is operated owing to inductive coupling generated by alternating magnetic field energy at the coil antenna of the reader/writer 32 to execute data reading and writing and to read and write data by means of the irradiated radio waves from the plate-shaped antenna of the reader/writer 32.

The reader/writer 34 provided with an antenna 35 according to the other embodiment as shown in FIG. 9 includes a circuit of the radio wave system and outputs radio waves at two different frequency bands via the plate-shaped antenna. For example, the reader/writer 35 outputs radio waves set at 860 MHz of the UHF band to actuate the power section of the wireless IC tag 7 loaded with the wireless IC tag main body 71, and then outputs radio waves set at 2.45 GHz of the microwave band to execute data reading and writing.

Now, the wireless IC tag 2 described above and the wireless IC tag communication system 1 using the reader/writer 3 will be explained. The wireless IC tag communication system 1 is a communication system to carry out radio communication between a wireless IC tag 2 and the reader/writer 3 and is the radio communication system using radio waves respectively set at two different frequencies, wherein the power section is actuated by means of radio waves of a first frequency and data reading and writing is executed by means of radio waves of a second frequency.

In response to the output of radio waves at 125 KHz as the first frequency for electrically activating a wireless IC tag 2 by the reader/writer 3, the power section of the wireless IC tag 2 locating within the communication range receives said radio waves is activated to actuate the memory section 22 and driving circuits, thereby causing the wireless IC tag 2 to operate and to generate the operational radio waves therefrom. The reader/writer 3 which received radio waves (e.g. an identifier of wireless IC tag 2) from the wireless IC tag 2 is positioned in the range where data reading and writing can be accomplished, said reader/writer is adapted to output radio waves at 13.56 MHz for reading and writing data to the wireless IC tag 2 to securely carry out data reading and writing. When a plurality of wireless IC tags 2 are existing in a communication range, the reader/writer 3 may recognize the plural IC tags 2 by virtue of the anti-collision function, whereby reading and writing information from/to all of the wireless IC tags 2 locating in the communication range, or from/to only a predetermined wireless IC tags 2 those which correspond to a specific identifier.

Now, the wireless IC tag 6 and the wireless IC tag communication system 11 using a reader/writer 32 will be explained. The wireless IC tag communication system 11 is a radio communication system to carry out radio communication between a wireless IC tag 6 and the reader/writer 32 and is the radio communication system using radio waves respectively set at two different frequencies, wherein the power section is actuated by means of radio waves of the first frequency and data reading and writing is achieved by means of radio waves of the second frequency.

In response to the output of radio waves at 13.56 MHz for electrically activating the wireless IC tag 6 from the coil antenna, the power section of the wireless IC tag 6 locating within the communication range receives said radio waves and is activated to actuate the memory section 62 and the other driving circuits, thereby causing the wireless IC tag 6 to operate and to generate the operational radio waves therefrom. The reader/writer 32 which received radio waves (e.g. an identifier of wireless IC tag 6) from the wireless IC tag 6 is positioned in the range where data reading and writing can be accomplished, said reader/writer is adapted to output the radio waves at 860 MHz received from the plate-shaped antenna for reading and writing data to the wireless IC tag 6 to securely carry out data reading and writing. When a plurality of wireless IC tags 6 are existing in a communication range, the reader/writer 32 may recognize the plural IC tags 6 by virtue of the anti-collision function, whereby reading and writing information from/to all of the wireless IC tags 6 locating in the communication range, or from/to only a predetermined wireless IC tags 6 those which correspond to a specific identifier.

Now, the wireless IC tag 7 and the wireless IC tag communication system 12 using a reader/writer 34 will be explained in the following. The wireless IC tag communication system 12 is a radio communication system to carry out radio communication between a wireless IC tag 7 and the reader/writer 34 and is the radio communication system using radio waves respectively set at two different frequencies, wherein the power section is actuated by means of radio waves of the first frequency and data reading and writing is executed by means of radio waves of the second frequency.

In response to the output of radio waves at 860 MHz for electrically activating the wireless IC tag 7 via the plate-shaped antenna, the power section of the wireless IC tag 7 locating within the communication range receives said radio waves and is activated to actuate the memory section 72 and the other driving circuits, thereby causing the wireless IC tag 7 to operate and to generate the operational radio waves therefrom. The reader/writer 34 which received radio waves (e.g. an identifier of wireless IC tag 7) from the wireless IC tag 7 is positioned in the range where data reading and writing can be accomplished, said reader/writer 34 is adapted to output the radio waves at 2.45 GHz received via the plate-shaped antenna for reading and writing data to the wireless IC tag 7 to thereby securely carry out data reading and writing. When a plurality of wireless IC tags 7 are existing in a communication range, the reader/writer 34 may recognize the plural IC tags 7 by virtue of the anti-collision function, whereby reading and writing information from/to all of the wireless IC tags 7 locating in the communication range, or from/to only a predetermined wireless IC tags 7 those which correspond to a specific identifier.

Many combinations of said reader/writers, said wireless IC tags and said communication frequency bands may be exemplified, and such combination may be selected appropriately in consideration with an environment for the use, such as a desired communication distance and communication speed, a medium through which radio waves are transmitted and the temperature of the medium. An example of such combinations of communication frequency bands having been commonly used for RFID tags, i.e. 125 KHz, 13.56 MHz, 433 MHz, 860 MHz and 2.45 GHz, are shown in the following table. The row represents the first frequency for electrically activating the wireless IC tag and the column represents the second frequency for reading and writing data from/to the wireless IC tag.

TABLE 1

| | 125 | | | | |
|---|---|---|---|---|---|
| | KHz | 13.56 MHz | 433 MHz | 860 MHz | 2.45 GHz |
| 125 KHz | — | ∘ | ∘ | ∘ | ∘ |
| 13.56 MHz | ∘ | — | ∘ | ∘ | ∘ |
| 433 MHz | ∘ | ∘ | — | ∘ | ∘ |
| 860 MHz | ∘ | ∘ | ∘ | — | ∘ |
| 2.45 GHz | ∘ | ∘ | ∘ | ∘ | — |

As the last example, the wireless IC tag communication system using the wireless IC tag 2, when it is used in the maintenance program for a concrete construction, is shown in FIG. 7 in the form of a flow chart. The wireless IC tags 2 are mixed into fresh concrete during the preparation stage 81 and kneaded together with an aggregate and water. At the preparation stage 81, the shipping stage 82, the carrying-in stage 83 to a construction site, the construction stage 84, the inspection stage 85 after completion of construction, the repairing stage 86 and the like of fresh concrete as shown in FIG. 7, various information are written to the wireless IC tags 2, and the written information is read from the wireless IC tags 2.

At the preparation stage 81 of fresh concrete, information on the prepared concrete, such as the name of manufacturing factory of the concrete, the product number, the manufacturing date and time, the raw materials such as cement and aggregate, the recipe of the concrete, the actual weighed values of the material used, the name of the responsible for the construction, will be written to the wireless IC tags, said wireless IC tags are then mixed into fresh concrete and kneaded therewith. Then, at the shipping stage 82, information on the shipment, such as the shipping date and information on starting the shipment being the most important information, the destination to be shipped, and the quantity of shipment, will be written to the wireless IC tags. Next, at the carrying-in state 83 to a construction site, information on the carrying-in, such as information on the unloading works including the time having had required for a work of from the shipment till the unloading will be written and read to/from the wireless IC tags. And, at the construction stage 84, information on casting of concrete including the time having had required for a work of from the unloading till the casting will be written and read to/from the wireless IC tags.

As shown in FIG. 2, at the inspection stage 85 on safety and the like or the repairing stage 86, after the completion of the construction of a concrete construction, information stored in the wireless IC tags 2 will be read in the wireless IC tag communication system 4 using the reader/writer 3 for concrete constructions, and new information will be written to the wireless IC tags 2.

When a user who reads or writes data from/to the wireless IC tags turns on the reader/writer 3, the reader/writer is adapted to output radio waves at a first frequency for causing the memory section of the wireless IC tag 2 to operate and radio waves at a second frequency for reading and writing data to actuate the power section by means of the radio waves at a first frequency, thereby causing the wireless IC tag 2 to output radio waves and further to read and write data by means of the radio waves at a second frequency.

Now, the wireless IC tag 2 and the wireless IC tag communication system 1 using a reader/writer 3 will be explained in the following. The wireless IC tag communication system 1 is a radio communication system to carry out radio communication between a wireless IC tag 2 and the reader/writer 3 and is the radio communication system using radio waves respectively set at two different frequencies, wherein the power section is actuated by means of radio waves of the first frequency and data reading and writing is executed by means of radio waves of the second frequency.

In response to the output of radio waves at 125 KHz for electrically activating and actuating the wireless IC tag 2 by the reader/writer 3, radio waves are output to the range of from 180 to 200 mm in depth (in the concrete). The wireless IC tag 2 having had received those radio waves generates driving radio waves. The reader/writer 3 that received the radio waves from the wireless IC tag 2 comes close to a position 30 mm apart from the wireless IC tag 2 and is adapted to output radio waves at 13.56 MHz for reading and writing data to securely execute data reading and writing in between two locations with a communication distance of approximately 25 to 30 mm (in the concrete). The distance described hereinabove varies depending on the output performance of the reader/writer 3, the kind of a medium in which radio waves are transmitted, such as air, concrete and water, and temperatures, and the frequency of output radio waves, the output power and the receivable frequency of the wireless IC tag will be selected case by case in consideration of the distance.

Note that the wireless IC tag communication system according the present invention is not limited to the communication using wireless IC tags to be mixed to a concrete construction, but the system may be used for data reading and writing via radio communication in a wide range, such as wireless IC tags installed in a park, a motor pool and the like, and for radio communication using wireless IC tags, the locations thereof are unknown, such a case that wireless IC tags are embedded in the underground.

### INDUSTRIAL USE OF THE INVENTION

The wireless IC tag communication system comprises a reader/writer for reading and writing data from/to a wireless IC tag by means of radio communication and a wireless IC tag in which a memory section and an antenna section are mounted on a substrate, said reader/writer outputs radio waves at a first frequency for electrically activating the wireless IC tag and radio waves at a second frequency for reading writing data, wherein the second frequency is different from the first frequency, to electrically activate the wireless IC tag by means of the radio waves at the first frequency and to execute data writing and reading, thereby operating the power section of the wireless IC tag by means of the radio waves at a first frequency capable of executing relatively long distance communication, and reading and writing data by means of the radio waves at a second frequency from/to the activated wireless IC tag so that data reading and writing from/to the wireless IC tag so-called RFID tag may be securely achieved via long distance communication. Further, according to this system, data reading and writing may be completed with influence of less noise. In particular, data reading and writing from/to the wireless IC tags, which are mixed and embedded in a concrete construction and their locations cannot be known from the outside, may be achieved securely.

1. A wireless IC tag communication system comprising a reader/writer for reading and writing data from/to a wireless IC tag via radio communication and a wireless IC tag in which a memory section and an antenna section are mounted on a substrate, wherein said reader/writer outputs radio waves at a first frequency for electrically activating the wireless IC tag and radio waves at a second frequency for writing and reading data, said second frequency is different from the first frequency, to thereby electrically activate the wireless IC tag with the radio waves at a first frequency and execute data writing and reading with the radio waves at a second frequency.

2. A wireless IC tag communication system according to claim 1, wherein the reader/writer alternately outputs radio waves at a first frequency for electrically activating the wireless IC tag and radio waves at a second frequency for writing and reading data to thereby cause the wireless IC tag to operate and to read and write data.

3. A wireless IC tag communication system according to claim 1, wherein the reader/writer simultaneously outputs radio waves at a first frequency for electrically activating the wireless IC tag and radio waves at a second frequency for writing and reading data to thereby cause the wireless IC tag to operate and to read and write data.

4. A wireless IC tag communication system according to claim 1, wherein the reader/writer and the wireless IC tag carry out communication by means of the electromagnetic induction system.

5. A wireless IC tag communication system according to claim 1, wherein the reader/writer and the wireless IC tag carry out communication by means of the radio wave system.

6. A reader/writer for writing and reading data to/from a wireless IC tag via radio communication, characterized in that the reader/writer outputs radio waves at a first frequency for electrically activating the wireless IC tag and radio waves at a second frequency for writing and reading data.

7. The reader/writer according to claim 6, characterized by alternately outputting radio waves at a first frequency for electrically activating the wireless IC tag and radio waves at a second frequency for reading and writing data.

8. The reader/writer according to claim 6, characterized by simultaneously outputting radio waves at a first frequency for electrically activating the wireless IC tag and radio waves at a second frequency for reading and writing data.

9. The reader/writer according to claim 6, wherein the reader/writer includes an electromagnetic induction circuit and outputs radio waves by means of the electromagnetic induction system, which generates alternating magnetic field by applying alternating current to a coil antenna.

10. The reader/writer according to claim 6, wherein the reader/writer includes a reflection circuit and outputs radio waves by means of the radio wave system, which establish communication between a wireless IC tag and a communication tag by using radio waves being reflected to a plate-shaped antenna.

11. A wireless IC tag characterized in that it receives radio waves at a first frequency for electrically activating the wireless IC tag and radio waves at a second frequency for writing and reading data, said second frequency is different from the first frequency and both of said radio waves are output from the reader/writer, and includes either an electromagnetic induction circuit to receive radio waves via a coil antenna or a reflection circuit to receive radio waves via a plate-shaped antenna, or both of an electromagnetic induction circuit to receive radio waves via said coil antenna and a reflection circuit to receive radio waves via said plate-shaped antenna.

12. A wireless IC tag according to claim 11, wherein the memory section consisting of the wireless IC tag is a non-volatile memory utilizing a ferroelectric comprising a power section which receives radio waves from the reader/writer and resonate with said radio waves to generate current.

13. A wireless IC tag communication system according to claim 2, wherein the reader/writer and the wireless IC tag carry out communication by means of the electromagnetic induction system.

14. A wireless IC tag communication system according to claim 3, wherein the reader/writer and the wireless IC tag carry out communication by means of the electromagnetic induction system.

15. A wireless IC tag communication system according to claim 2, wherein the reader/writer and the wireless IC tag carry out communication by means of the radio wave system.

16. A wireless IC tag communication system according to claim 3, wherein the reader/writer and the wireless IC tag carry out communication by means of the radio wave system.

17. A wireless IC tag communication system according to claim 4, wherein the reader/writer and the wireless IC tag carry out communication by means of the radio wave system.

18. A wireless IC tag communication system according to claim 13, wherein the reader/writer and the wireless IC tag carry out communication by means of the radio wave system.

19. The reader/writer according to claim 7, wherein the reader/writer includes an electromagnetic induction circuit and outputs radio waves by means of the electromagnetic induction system, which generates alternating magnetic field by applying alternating current to a coil antenna.

20. The reader/writer according to claim 8, wherein the reader/writer includes an electromagnetic induction circuit and outputs radio waves by means of the electromagnetic induction system, which generates alternating magnetic field by applying alternating current to a coil antenna.
